(19) United States
(12) Patent Application Publication
(10) Pub. No.: US 2007/0041708 A1
(43) Pub. Date: Feb. 22, 2007

(54) Recording medium including user operation information on button, playback device, and playback method

(75) Inventors: Kil-soo Jung, Hwaseong-si (KR); Man-seok Kang, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/487,379

(22) Filed: Jul. 17, 2006

(30) Foreign Application Priority Data
Aug. 16, 2005 (KR) 2005-74925

(51) Int. Cl. H04N 7/00

(52) U.S. Cl. 386/95

(57) ABSTRACT

A recording medium including menu stream data including menu information provided such that a button displayed on a screen can be selected. The menu stream data includes user operation (UPO) information for determining a user operation of the button. Accordingly, a button selection UOP or a selection button execution UOP may be executed in accordance with the intention of a user and/or a manufacturer.

### CROSS-REFERENCE TO RELATED APPLICATION

This application claims the benefit of Korean Patent Application No. 2005-74925, filed Aug. 16, 2005, in the Korean Intellectual Property Office, the disclosure of which is incorporated herein by reference.

### BACKGROUND OF THE INVENTION

1. Field of the Invention

An aspect of the present invention relates to a recording medium including user operation (UOP) information on a button that is input by a user, a playback apparatus, and a playback method.

2. Description of the Related Art

In audio-visual data to provide a high-quality moving picture, a button is provided to interact with a user. Such a button includes information on an object which is displayed on a screen, color information of a button object, location information of a button which will be displayed on the screen, button number information to facilitate the selection and execution of the button using a number key of a user input device, neighboring button information to provide for movement of a button to its neighboring button using a direction key of the user input device, and information on an instruction, which is executed upon executing a button.

When a plurality of buttons is displayed on a screen, a specific button is relatively easily selected and executed using a number key to allow for access to the specific button. A playback device provides a number key to a user input device such that a button is selected and executed by allowing a user to input only a desired button number, without sequential navigation.

However, if the user inputs a specific button number using the number key of the user input device, user operation information on the input button number is arbitrarily set in the playback device. Accordingly, when the user inputs the number key, an operation related to the input button number is executed regardless of the intention of a user or a content manufacturer.

### SUMMARY OF THE INVENTION

An aspect of the present invention provides a recording medium including user operation (UOP) information on a button that is input by a user, a playback device, and a playback method. Another aspect of the present invention also provides a recording medium, a playback device, and a playback method, which execute a button selection UOP or a selection button execution UOP in accordance with the intention of a user and/or a manufacturer.

According to an aspect of the present invention, there is provided a recording medium including: menu stream data including menu information provided such that a button displayed on a screen is selectable, wherein the menu stream data includes user operation (UOP) information to determine a user operation of the button.

The user operation may include button selection to select the button or selection button execution to select and execute the button. The user operation information may be stored as masking information in the menu stream data and be set such that only one of button selection to select the button and selection button execution to select and execute the button is allowed, or neither the button selection or the selection button execution are allowed.

The user operation information may be included as menu type information to determine the user operation in accordance with a menu type included in the menu stream data. The menu type information may indicate the button selection if the menu type is a playback selection menu to change a playback location in accordance with the selection of a user, and indicate the selection button execution if the menu type is a status change menu to change a playback set status in accordance with the selection of the user. The user operation information may be assigned to button information included in the menu stream data.

The user operation information may be set such that only one of button selection to select the button and selection button execution to select and execute the button is allowed, or neither the button selection or the selection button execution are allowed, and be used as a system parameter stored in a system register included in a playback device for playing the recording medium. When the system parameter is used, the user operation information stored as the masking information in the menu stream data may be set such that both the button selection and the selection button execution are allowed.

According to another aspect of the present invention, there is provided a playback device to read data from a recording medium and to play the data including: a playback control engine which reads from the recording medium menu stream data including menu information provided such that a button displayed on a screen is selectable, and controls playback of the menu information; and a presentation engine which reads moving picture information from the recording medium and decodes the moving picture information in accordance with control of the playback control engine, wherein the playback control engine obtains user operation information to determine a user operation of the button included in the menu stream data and executes the operation of the button based on the user operation information.

According to another aspect of the present invention, there is provided a playback method to read data from a recording medium and to play the data including: reading from the recording medium user operation information to determine a user operation of a button included in menu stream data including menu information provided such that a button displayed on a screen is selectable; and executing the operation of the button based on the user operation information.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a playback system according to an embodiment of the present invention;

FIG. 2 illustrates a playback device according to an embodiment of the present invention;

FIG. 3 illustrates menu stream data including UOP masking information according to an embodiment of the present invention;

FIG. 4 illustrates menu stream data including menu type information for setting UOP information depending on a menu type, according to an embodiment of the present invention;

FIG. 5 illustrates menu stream data including UOP information which is set to button information, according to an embodiment of the present invention;

FIG. 6 illustrates a system parameter stored in a system register of a playback device for storing the UOP information according to an embodiment of the present invention; and

FIG. 7 is a flowchart illustrating a playback method according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

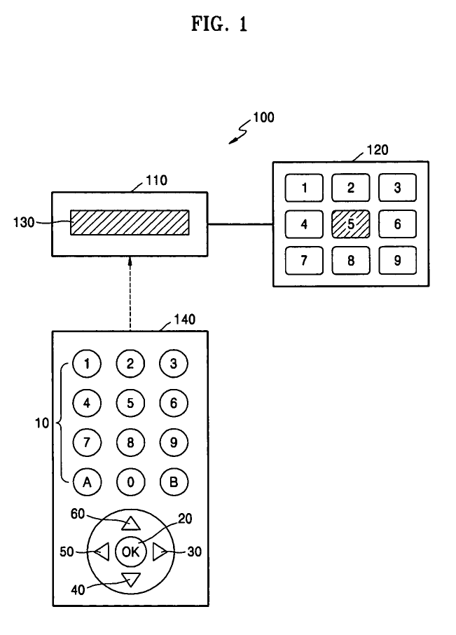

FIG. 1 illustrates a playback system 100, according to an embodiment of the present invention. The playback system 100 includes a playback device 110, a display device 120 (which may be a part of the playback device 110 and vice versa), and a user input device 140. The playback device 110 decodes data stored in a recording medium 130 such as a DVD and the display device 120 receives and outputs the decoded data. A user operation (hereinafter, referred to as UOP) which may be processed by the playback device 110 includes a button (or a button number) selection UOP and a selection button (button number) execution UOP.

When a user tries to execute data corresponding to any button number, if the button selection UOP is selected, a button corresponding to an input button number is selected and then the button execution UOP is operated by the pressing of an execution button (OK button) 20 included in the user input device 140 to execute the button. If the selection button execution UOP is selected, the button corresponding to the input button number is selected and then executed.

Menu stream data, including menu information as well as moving picture information, is stored in the recording medium 130. A button number for each button is assigned to the menu stream data such that the button displayed on a screen may be directly selected by a number key of the user input device 140. Furthermore, the menu stream data includes UOP information to cause the UOP to be executed when the user inputs the button number.

The user input device 140 having the number key, such as a remote controller, receives the button number of the user and sends the button number to the playback device 110. The playback device 110 receives the button number, reads UOP information on the button number from the recording medium 130, and executes the UOP. Accordingly, if the UOP information on the button number is the button selection UOP, the button number displayed on the display device 120 is selected, and if the UOP information on the button number is the selection button execution UOP, the selected button is immediately executed such that data corresponding to the button is provided to the user.

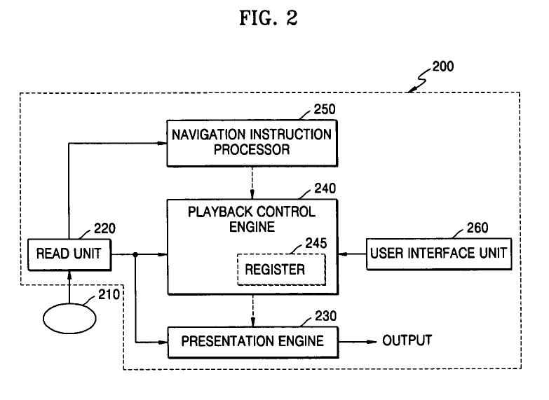

FIG. 2 illustrates a playback device, according to an embodiment of the present invention. The playback device 200 includes a read unit 220, a presentation engine 230, a playback control engine 240, a navigation instruction processor 250, and a user interface unit 260. The read unit 220 reads data from the recording medium 210 and provides the data to the presentation engine 230 and the playback control engine 240. The recording medium 210 stores moving picture data and the menu stream data including masking information, menu type information, and UOP information included in the button information. The presentation engine 230 decodes the moving picture data stored in the recording medium 210.

The playback control engine 240 controls a playback of menu information in accordance with the menu stream data including the menu information stored in the recording medium 210, such that the button displayed on the screen may be selected. The playback control engine 240 controls the playback such that the UOP information, included in the menu stream data, is read from the recording medium 210 and the button selection UOP or the selection button execution UOP of the button number input by the user is executed. The playback control engine 240 also analyzes playback sequence information to define the playback sequence of the moving picture data.

The playback engine 240 includes a system register 245 including the UOP information. When the masking information stored in the recording medium 210 allows both UOPs, the playback device 200 reads a system parameter of the system register 245 and, on that basis, determines the nature of the UOP. The system parameter of the system register 245 may be set and changed by the user or the manufacturer of the recording medium 210.

The playback device 200 includes the navigation instruction processor 250 to analyze a navigation instruction, and the navigation instruction including UOP information applies to the system register 245 of the playback control engine 240. Accordingly, the system parameter may be set or changed by the UOP information included in the navigation instruction.

The playback device 200 may set or change the system register 245 using the user interface unit 260. The user interface unit 260 provides a set menu to allow the user to set the system parameter and to apply a set value input by the user to the system register.

The instruction related to the playback of the moving picture is analyzed and sent to the playback control engine 240, and the playback control engine 240 controls the playback such that the presentation engine 230 decodes and outputs the corresponding moving picture with reference to a playback title, the playback sequence information, and the parameter of the system register.

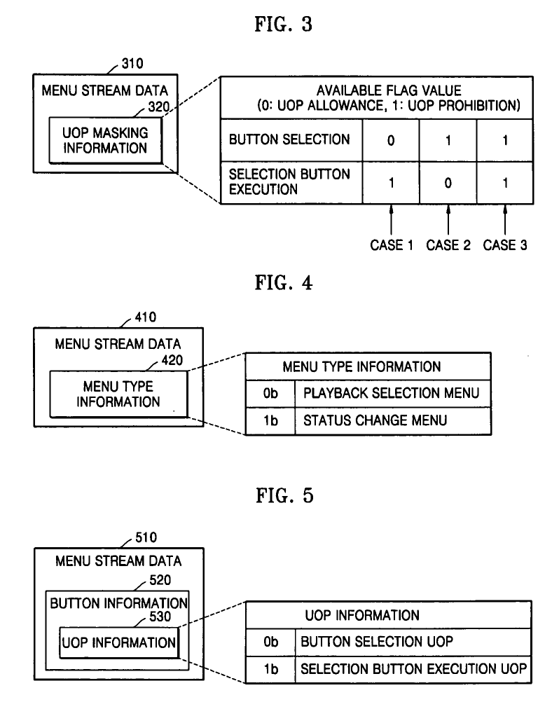

FIGS. 3 through 6 illustrate the button operation information included in the menu stream data stored in the recording medium (i.e., the recording medium 130 of FIG. 1 or the recording medium 210 of FIG. 2) such that the operation of the button provided in the menu is set in accordance with the intention of a content provider. FIG. 3 illustrates menu stream data including UOP masking information according an embodiment of the present invention.

The menu stream data 310 stored in the recording medium includes masking information 320 as the UOP information, which determines the UOP operation of the user input, and flag information to indicate whether the UOP is allowed in the masking information. In the flag information, 0 represents allowance of the UOP and 1 represents prohibition of the UOP.

The masking information 320 is set to allow only one of the button selection UOP and the selection button execution UOP, but not both UOPs, to be in effect. In FIG. 3, case 1 represents the case where only the button selection UOP is allowed, case 2 represents the case where only the selection button execution UOP is allowed, and case 3 represents the case where neither UOP is allowed.

Accordingly, if the flag information is set to case 1 in the menu stream data of the recording medium, the playback device executes only the button selection UOP for the button number input by the user. If the flag information is set to case 2, the playback device executes only the selection button execution UOP for the button number input by the user. If the flag information is set to case 3, neither UOP is allowed. Accordingly, in case 3, the user cannot select the button number or execute the data corresponding to the button number by number button (10) of the user input device 40 shown in FIG. 1. That is, in order to select or execute the data corresponding to the button number in case 3, the user should use direction keys 30, 40, 50, and 60 and an execution button 20 of the user input device 140 shown in FIG. 1. Accordingly, the content manufacturer may set the method of executing the button number by setting the allowance or prohibition of the UOP in the menu stream data stored in the recording medium.

FIG. 4 illustrates menu stream data including menu type information to allow for a setting of UOP information depending on a menu type, according to an embodiment of the present invention.

Generally, menus for movies can be classified into playback selection menus and status change menus. The playback selection menu allows for a selection of a target to be played, such as a title or chapter menu to change a playback location, and the status change menu, which is an audio or sub-title menu to change the playback setting in a current playback location.

These menus use the button selection UOP and the selection button execution UOP in accordance with their characteristics. More particularly, in the playback selection menu, if the user inputs a button number, the button selection UOP provides a thumbnail image and a summary of the selected title or chapter to the user, the user is allowed to select the playback location, and the selected menu is executed. In the status change menu, if the user inputs a button number, the selection button execution UOP is executed to change the set status of the audio and the sub-title.

Accordingly, in the recording menu, according to an embodiment of the present embodiment, the menu stream data 410 includes menu type information 420. When the user inputs a button number, the playback device reads the menu type information from the recording medium to store the menu type information of FIG. 4 and executes the UOP corresponding to the button number. That is, the playback device executes the button selection UOP when the value of the menu type information is 0b (that is, the playback selection menu) and executes the selection button execution UOP when the value of the menu type information is 1b (that is, the status change menu).

FIG. 5 illustrates menu stream data including UOP information which is set to button information, according to an embodiment of the present invention.

In a specific menu page, when the user inputs a button number, the button may be selected or the button may be selected and executed. Accordingly, in the recording medium (i.e., the recording medium 130 of FIG. 1 or the recording medium 210 of FIG. 2) according to an embodiment of the present embodiment, the button information 520 in the menu stream data 510 includes UOP information 530 which is executed when the user inputs the button number.

Accordingly, when the user inputs the button number, the playback device executes the button selection UOP if the value of the UOP information is 0b, and executes the selection button execution UOP if the value of the UOP information is 1b.

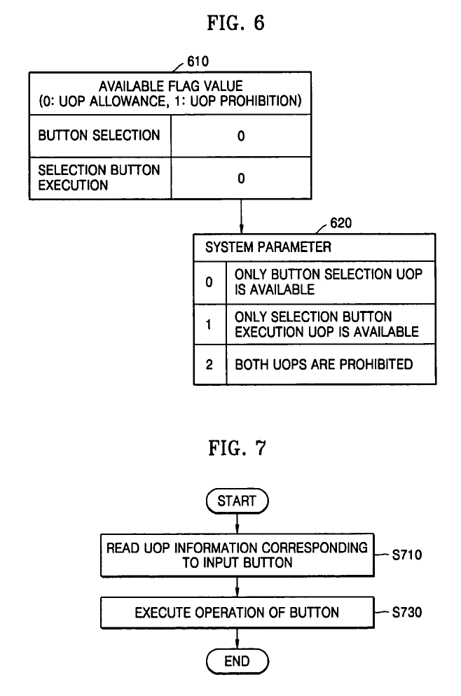

FIG. 6 illustrates a system parameter stored in a system register of a playback device to store UOP information according to an embodiment of the present invention. As shown in FIG. 6, the playback device determines the UOP with reference to the system parameter 620 stored in the system register of the playback device when playing the recording medium in which the flag information in the masking information 610 is set to allow both the button selection UOP and the selection button execution UOP upon a manufacturing of the menu stream data. Furthermore, the system parameter may be set to allow only one of the two UOPs and to prohibit both UOPs. In FIG. 6, if the system parameter is set to 0, only the button selection UOP is available, if the system parameter is set to 1, only the selection button execution UOP is available, and if the system parameter is set to 2, both UOPs are prohibited.

The system register may be classified into two types. In a first type system register, the system parameter is set when the playback device is initiated, the system parameter may be input in a state that the system set menu is provided upon non-playback, and the system parameter is not changed upon playback. In a second type system register, the system parameter may be changed by various navigation instructions upon playback as well as when the playback device is initiated.

The first type system register may be set or changed by providing a user with the menu to allow for a setting of the UOP to the register of the playback device before playback, such that the user may set or change the system parameter of the system register.

The second type system register may be set or changed by executing the navigation instruction defined by the content manufacturer. The system parameter of the second type system register may be changed if necessary in the respective operations of analyzing the navigation instructions before the playback of a specific playback unit. Thus, the UOP may be changed in the respective playback unit.

Accordingly, if the user inputs a button number in the playback device including the system register of FIG. 6, the playback device executes the UOP with reference to the system register including the information to determine the UOP to be executed.

FIG. 7 is a flowchart illustrating a playback method according to an embodiment of the present invention. As shown in FIG. 7, when the user inputs a button number, the user operation information to determine the user operation of the button included in the menu stream data including the menu information provided such that the buttons displayed on the screen may be selected is read from the recording medium (op 710).

The UOP information corresponding to the button number may be read from the masking information in the menu stream data. Furthermore, the UOP information may be read from the menu type information in the menu stream data. When the menu type is the playback selection menu, the menu type information indicates the button selection UOP, and when the menu type is the status change menu, the menu type information indicates the selection button execution UOP. Also, the UOP information assigned to the button information in the menu stream data stored in the recording medium can be read.

Based on the read user operation information, the operation of the button is executed (op 730).

The invention may also be embodied as computer readable code on a computer readable recording medium. The computer readable recording medium is any data storage device that may store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the internet), or combinations thereof. The computer readable recording medium may also be distributed over network coupled computer systems so that the computer readable code is stored and executed in a distributed fashion.

According to aspects of the present invention, a button selection UOP or a selection button execution UOP may be executed in accordance with the intention of a user and/or a manufacturer. Furthermore, according to other aspects of the present invention, a content manufacturer may set the UOP so that the UOP is adequately executed in a playback unit and a user may set the UOP in advance to be executed during the playback.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A recording medium comprising menu stream data including menu information provided such that a button displayed on a screen is selectable, wherein the menu stream data includes user operation (UOP) information to determine a user operation of the button.

2. The recording medium according to claim 1, wherein the user operation includes a button selection to select the button or selection button execution to select and execute the button.

3. The recording medium according to claim 1, wherein the user operation information is stored as masking information in the menu stream data and is set such that only one of button selection to select the button and selection button execution to select and execute the button is allowed, or neither the button selection or the selection button execution are allowed.

4. The recording medium according to claim 1, wherein the user operation information is included as menu type information to determine the user operation in accordance with a menu type included in the menu stream data, and the menu type information indicates the button selection to select the button if the menu type is a playback selection menu to change a playback location in accordance with the selection of a user, and indicates the selection button execution to select and execute the button if the menu type is a status change menu to change a playback set status in accordance with the selection of the user.

5. The recording medium according to claim 1, wherein the user operation information is assigned to button information included in the menu stream data.

6. The recording medium according to claim 1, wherein the user operation information is set such that only one of button selection to select the button and selection button execution to select and execute the button is allowed, or neither the button selection or the selection button execution are allowed, and is used as a system parameter stored in a system register included in a playback device to play the recording medium.

7. The recording medium according to claim 6, wherein, when the system parameter is used, the user operation information stored as the masking information in the menu stream data is set such that both the button selection and the selection button execution are allowed.

8. A playback device to read data from a recording medium and to play the data, comprising:
a playback control engine, which reads menu stream data, including menu information provided such that a button displayed on a screen is selectable, from the recording medium, and which controls a playback of the menu information; and
a presentation engine, which reads moving picture information from the recording medium and decodes the moving picture information in accordance with the control of the playback control engine, wherein the playback control engine obtains user operation information to determine a user operation of the button included in the menu stream data and executes the operation of the button based on the user operation information.

9. The playback device according to claim 8, wherein the playback control engine obtains the user operation information to determine button selection to select the button or selection button execution to select and execute the button and executes the operation of the button based on the user operation information.

10. The playback device according to claim 8, wherein the playback control engine obtains the user operation information stored as masking information in the menu stream data and executes the operation of the button based on the user operation information, and the user operation information is set such that only one of button selection to select the button and selection button execution to select and execute the button is allowed, or neither the button selection or the selection button execution are allowed.

11. The playback device according to claim 8, wherein the playback control engine obtains the user operation information stored as menu type information to determine the user operation in accordance with a menu type included in the menu stream data, and executes the operation of the button based on the user operation information, and the menu type information indicates button selection to select the button if the menu type is a playback selection menu to change a playback location in accordance with the selection of a user, and indicates selection button execution to select and execute the button if the menu type is a status change menu to change a playback set status in accordance with the selection of the user.

12. The playback device according to claim 8, wherein the playback control engine obtains the user operation information assigned to button information included in the menu stream data and executes the operation of the button based on the user operation information.

13. The playback device according to claim 8, wherein the playback control engine includes a system register including a system parameter indicating the user operation information, obtains the user operation information from the system register, and executes the operation of the button based on the user operation information, wherein the system parameter is set such that only one of the button selection to select the button and the selection button execution to select and execute the button is allowed, or neither the button selection or the selection button execution are allowed.

14. The playback device according to claim 13, further comprising a navigation instruction processor to analyze a navigation instruction which is read from the recording medium, the navigation instruction processor including information to set the system parameter.

15. The playback device according to claim 13, further comprising a user interface unit which provides a set menu such that the system parameter is set and applies a user input to the system parameter to set the system parameter.

16. The playback device according to claim 13, wherein, when obtaining the user operation information set by the system parameter and executing the operation of the button based on the user operation information, the user operation information stored as the masking information in the menu stream data is set such that both the button selection and the selection button execution are allowed.

17. A playback method for reading data from a recording medium and playing the data, comprising:
reading user operation information to determine a user operation of a button included in menu stream data from the recording medium, the menu stream data including menu information provided such that a button displayed on a screen is selectable; and
executing the operation of the button based on the user operation information.

18. The playback method according to claim 17, wherein the user operation includes button selection to select the button and selection button execution to select and execute the button.

19. The playback method according to claim 17, wherein the reading of the user operation information comprises reading the user operation information stored as masking information in the menu stream data, and wherein the user operation information is set such that only one of the button selection to select the button and the selection button execution to select and execute the button is allowed, or neither the button selection or the selection button execution are allowed.

20. The playback method according to claim 17, wherein the reading of the user operation information comprises reading menu type information in the menu stream data, and wherein the menu type information indicates the button selection to select the button if the menu type is a playback selection menu to change a playback location in accordance with the selection of a user, and indicates the selection button execution to select and execute the button if the menu type is a status change menu to change a playback set status in accordance with the selection of the user.

21. The playback method according to claim 17, wherein the reading of the user operation information comprises reading the user operation information assigned to button information included in the menu stream data.

22. The playback method according to claim 17, wherein the reading of the user operation information comprises reading a system parameter stored in a system register included in a playback device to play the recording medium, and wherein the system parameter is set such that only one of the button selection to select the button and the selection button execution to select and execute the button is allowed, or neither the button selection or the selection button execution are allowed.

23. The playback method according to claim 22, wherein the system parameter is set by the user operation information included in a navigation instruction read from the recording medium or by a user input.

24. The playback method according to claim 22, wherein, when the user operation information set by the system parameter is executed, the user operation information stored as the masking information in the menu stream data is set such that both the button selection and the selection button execution are allowed.

25. A computer-readable medium having embodied thereon a computer program to execute the method of claim 17.

26. A computer-readable medium having embodied thereon a computer program to execute the method of claim 18.

27. A computer-readable medium having embodied thereon a computer program to execute the method of claim 19.

28. A computer-readable medium having embodied thereon a computer program to execute the method of claim 20.

29. A computer-readable medium having embodied thereon a computer program to execute the method of claim 21.

30. A computer-readable medium having embodied thereon a computer program to execute the method of claim 22.

31. A computer-readable medium having embodied thereon a computer program to execute the method of claim 23.

32. A computer-readable medium having embodied thereon a computer program to execute the method of claim 24.

33. A recording medium for use with a recording/reproducing apparatus on which menu stream data is recorded, the menu stream data comprising:
menu information provided such that a button displayed on a display coupled to the recording/reproducing apparatus may be selected; and
user operation (UOP) information, including a button selection to select the button or selection button execution to select and execute the button, to determine a user operation of the button in accordance with the intention of a user and/or a manufacturer, the user operation information being stored as masking information in the menu stream data and being set such that only one of button selection to select the button and selection button execution to select and execute the button is allowed, or such that neither the button selection or the selection button execution are allowed.
